(19) United States
(12) Patent Application Publication
(10) Pub. No.: US 2026/0167852 A1
(43) Pub. Date: Jun. 18, 2026

(54) ADHESIVE RESIN COMPOSITION FOR SURFACE MODIFICATION, MANUFACTURING, METHOD AND USES THEREOF

(71) Applicant: Magnekon, S.A. de C.V., San Nicolás de Los Garza (MX)

(72) Inventors: Juan Carlos MORALES HUERTA, San Nicolás de Los Garza (MX); Edgar Alberto DUARTE PEÑA, San Nicolás de Los Garza (MX); Francisco DÍAZ CAMACHO, San Nicolás de Los Garza (MX)

(21) Appl. No.: 18/984,489

(22) Filed: Dec. 17, 2024

(51) Int. Cl. C09J 175/06; C09J 7/35

(52) U.S. Cl. CPC C09J 175/06; C09J 7/35; C09J 2301/10; C09J 2301/304; C09J 2301/50; C09J 2463/006; C09J 2479/086

(57) ABSTRACT

The present invention relates to an adhesive resin including dispersions of phenoxy resins and polyurethane dispersions, and which is applied to surfaces of materials with low thermodynamic compatibility for the purpose of improving surface adhesion between said incompatible materials. The resin composition object of the present invention has application in the technical field of coatings and adhesives.

### FIELD OF THE INVENTION

The present invention relates generally to an adhesive resin comprising dispersions of phenoxy resins and polyurethane dispersions, which is primarily designed for surface modification, with the aim of providing a suitable surface energy to facilitate adhesion between materials that would otherwise be thermodynamically incompatible. The resin object of the present invention has application in the technical field of coatings and adhesives.

### BACKGROUND OF THE INVENTION

A resin is a solid or highly viscous organic substance that may be natural or synthetic and is used in a variety of industrial and commercial applications. While a resin comprising dispersions of phenoxy resins and polyurethane dispersions refers to a composite material in which both types of dispersion are present. Phenoxy resins are thermoplastic polymers derived from the reaction between bisphenol A and epichlorohydrin, and in these dispersions, phenoxy resins are finely distributed in volatile solvents such as methyl ethyl ketone (MEK) and acetone.

On the other hand, polyurethane (PU) is a polymer formed by the reaction between a polyol (a compound with multiple hydroxyl groups) and an isocyanate (a compound with isocyanate groups). PU dispersions are synthesized by solution polymerization, where the polyol and isocyanate react in a 1:1 molar ratio in a solvent such as xylene, resulting in a polyurethane dispersion with viscosities less than 100 cP.

The combination of these dispersions in a single resin allows to take advantage of the properties of both. phenoxy resins provide good adhesive properties, chemical and thermal resistance, while polyurethane offers flexibility, durability and wear resistance.

The relevance of the above-mentioned resins in the coatings and adhesives industry is considerable since they offer a unique combination of adhesive properties, chemical and thermal resistance, flexibility and durability. Phenoxy resins, with their excellent adhesion and chemical resistance, and polyurethane resins, known for their flexibility and wear resistance, allow the creation of coatings and adhesives that significantly improve adhesion between surfaces. This outcomes in more durable and effective products, expanding the possibilities of industrial and commercial applications where adhesion and surface protection are critical.

In recent years, research and development in the field of coatings and adhesives have advanced significantly. However, currently, known adhesives fail to provide reliable and long-lasting adhesion between materials that are thermodynamically incompatible, and especially in materials i.e. polyimide films such as epoxy resins. This combination is especially relevant in the transformer (electric) industry, where secondary insulation is formed by layers of thermally enhanced insulating paper sandwiched between layers of magnet wire windings. The interlayer paper contains a pattern of epoxy adhesive and this adhesive, when activated by heat, bonds to the magnet wire surface ensuring that the windings remain bonded during assembly, transportation and the life of the transformer. Due to their chemical and surface nature, epoxy adhesives have low compatibility with polyimide films resulting in poor adhesion properties.

Therefore, the adhesives known today fail to adequately modify the surface energy of the treated surfaces, resulting in poor adhesion and reduced shelf life of the final products. The ability to create adhesives that can overcome these limitations is crucial to the development of more robust and versatile applications in various industries.

The above mentioned is a significant problem for Industries that rely on strong, long-lasting adhesion between diverse materials, such as the aforementioned transformer industry, automotive, aerospace, electronics, and construction. These industries require coatings and adhesives capable of bonding materials with incompatible thermodynamic properties, ensuring structural integrity, resistance to extreme environmental conditions, and product durability. The failure of current adhesives to provide these characteristics limits the performance and reliability of many critical products and components.

In the prior art, some documents tried to solve these deficiencies, e.g. the U.S. Pat. No. 8,419,918B2, published on Apr. 16, 2013, which describes a method for modifying the surface of a polyimide film, a method for manufacturing a flexible copper-coated laminate using the same, and a flexible copper-coated laminate (FCCL) having a two-layer structure thus manufactured. The method for modifying the surface of a polyimide film is carried out by modifying the surface of a polyimide film through a first plasma treatment, by immersing the polyimide film in a solution containing an ethyleneimine-based silane coupling agent.

On the other hand, the US patent application US20120231263A1, published on Oct. 30, 2018, describes a polyimide film and an adhesive layer and where the adhesive layer is selected from polyimide resins, epoxy resins, phenolic resins, melamine resins, acrylic resins, cyanate resins or combinations thereof. The polyimide film of said document is composed of a polyimide and a submicron filler, which can generally be incorporated into the polyimide with relatively high loads without causing the polyimide film to be unduly brittle, maintaining or decreasing the coefficient of thermal expansion and increasing the storage modulus. In addition, the submicron filler is less than the thickness of the polyimide film in all dimensions and can be present in an amount of 10 to 45 percent by volume of the polyimide film.

On the other hand, the document Enhanced surface free energy of polyimide fibers by alkali treatment and its interfacial adhesion behavior to epoxy resins, discloses polyimide fibers modified by alkaline treatments using a 20% aqueous NaOH solution by weight for a period of 1 to 10 minutes at a controlled temperature of 30° C.; resulting in an improvement in the surface properties of the fibers, slightly increasing the adhesion strength.

Consequently, due to the clear shortcomings of the prior art in providing adhesives and coatings that ensure reliable and long-lasting adhesion between thermodynamically incompatible materials, there remains a need to develop new resin formulations that can effectively modify the surface energy of treated surfaces. This includes the creation of phenoxy and polyurethane resin dispersions that offer improved adhesion, chemical resistance, flexibility and durability properties, thus addressing current limitations and expanding potential applications in various industries.

### SUMMARY OF THE INVENTION

In order to overcome the deficiencies of the state of the art, the different aspects of the present invention relate to a resin whose composition comprises dispersions of phenoxy resins and dispersions of polyurethane to improve the thermodynamic compatibility of two materials.

An object of the present invention to provide a resin whose composition improves the surface characteristics of a material, providing the surface energy necessary to facilitate adhesion between materials that normally do not adhere properly due to thermodynamic incompatibilities. These composite resins are mainly used in coatings and adhesives, where a surface modification is required to improve adhesion between different materials.

In another aspect of the invention, a process/method for obtaining the resin object of this invention is also described, as well as its uses.

Some advantages of the present invention lie in its ability to provide strong and long-lasting adhesion between materials that are thermodynamically incompatible, due to the unique combination and composition of phenoxy and polyurethane resin dispersions. This allows to significantly improve the surface energy of the treated surfaces, resulting in better adhesion. Furthermore, the combined properties of chemical and thermal resistance, flexibility and durability of these resins make them ideal for applications in coatings and adhesives in various industries, offering more robust and effective solutions to complex adhesion challenges.

Another advantage offered by the present invention is that the processing for the treatment of polyimide involves less technical complexity which in turn results in greater economic viability.

These and other objects and advantages will become apparent to those skilled in the art in view of the following description of the figures and the detailed description of the invention and the appended claims.

### BRIEF DESCRIPTION OF DRAWINGS

FIG. 1 shows how the adhesion tests between the polyimide tape and the epoxy elements were carried out in the context of the present invention.

FIG. 2 shows the comparative graph with the adhesion forces of a control without modification, and a test with the phenoxy resin and the PU resin according to the present invention.

FIG. 3 shows the polyimide tape wound with the adhesive.

### DETAILED DESCRIPTION OF THE INVENTION

Some aspects of the present invention will now be described in more detail with further reference to the accompanying drawings in which some embodiments and advantages of the present invention are shown.

It will be apparent to one skilled in the art that various embodiments of the invention may be expressed in many different ways and should not be construed as limited to the embodiments described herein; rather, these exemplary embodiments are provided so that this invention will be clear and complete, and will fully convey the scope of the invention to those skilled in the art. For example, unless otherwise indicated, something described as first, second, or the like should not be construed as being in any particular order. As used in the description and appended claims, the singular forms “a,” “an,” and “the” include plural referents unless the context clearly dictates otherwise.

The different aspects of the present invention relate to a resin designed primarily for surface modification, with the aim of providing adequate surface energy to facilitate adhesion between materials that would otherwise be thermodynamically incompatible.

In a particular embodiment, the resin object of the present invention comprises at least one dispersion of phenoxy resins and/or at least one polyurethane dispersion.

In the context of the present invention, “dispersion of phenoxy resins ” is understood as a homogeneous mixture in which the phenoxy resin particles are finely distributed in a solvent. Phenoxy resins are thermoplastic polymers derived from the reaction between bisphenol A and epichlorohydrin. In a dispersion, these resins are mixed with highly volatile solvents, such as methyl ethyl ketone (MEK) or acetone, in proportions generally varying between 10% and 40%. This formulation allows phenoxy resins to be handled and applied effectively, providing improved adhesive properties and chemical resistance in applications such as coatings and adhesives.

In the context of the present invention, the term “polyurethane dispersion ” refers to a homogeneous mixture in which the polyurethane is finely distributed in a solvent. The polyurethane is synthesized by the reaction of a polyol with an isocyanate, and in this dispersion, the result of that reaction is dissolved in a solvent, such as xylene. The dispersion is characterized by having viscosities less than 100 cP and is formed by solution polymerization. This formulation allows the polyurethane to be applied uniformly on various surfaces, improving adhesion and protection in coatings and adhesives, especially in applications where flexibility and wear resistance are required.

In a particular embodiment, the at least one suitable phenoxy resin dispersion according to the present invention is selected from the group comprising dispersions of phenoxy resins in organic solvents, dispersions of phenoxy resins in water, dispersions of high solids phenoxy resins, combinations thereof or the like.

In a preferred embodiment, the at least one phenoxy resin is a phenoxy resin in organic solvents, which comprises highly volatile solvents.

In a particular embodiment according to the above, the highly volatile solvents are selected from the group comprising methyl ethyl ketone (MEK), acetone, ethanol, toluene, and hexane, the like, or combinations thereof.

In a particular embodiment, at least one phenoxy resin is found in proportions ranging from 10% to 40% with respect to the total composition.

In a particular embodiment, the at least one polyurethane dispersion in the context of the present invention is any selected from the group comprising polyurethane dispersions in organic solvents, aqueous polyurethane dispersions, high solids polyurethane dispersions, combinations thereof or the like.

In a preferred embodiment, at least one polyurethane dispersion according to the present invention is synthesized by the solution polymerization method, wherein at least one polyol and at least one isocyanate are reacted in a 1:1 molar ratio in xylene.

In a particular embodiment related to the above, the at least one polyol is selected from the group comprising polyester diol polyols, polyester triol polyols, modified polyester polyols, poly(caprolactone) diol, combinations thereof or similar.

In another related particular embodiment, the at least one isocyanate is selected from the group comprising 4,4′-Methylenediphenyl diisocyanate (MDI), toluene diisocyanate (TDI), hexamethylene diisocyanate (HDI), isophorone isocyanate (IPDI), combinations thereof and the like.

In a particular related embodiment, the resin has a viscosity no greater than 100 cP and has B-Stage characteristics, which means that when the solvent evaporates, the resin is semi-activated, which must be subjected to a temperature greater than 120° C. so that it can be activated.

In a particular embodiment, the adhesive resin object of the present invention can be used on surfaces of different materials which have low thermodynamic compatibility due to their chemical and surface nature.

In a particular embodiment, some of the materials suitable for using the resin object of the present invention are selected from the group comprising a polyimide film, a PET film, a polyamide film (Nylon 6), epoxy adhesives, combinations thereof and the like.

In a particular embodiment, the adhesive resin object of the present invention is applied in coatings and industrial adhesives to form a final product which is selected from the group comprising adhesives for automobiles, transformers, aerospace components, electronic devices, construction materials, packaging, textiles, combinations thereof or the like.

Based on the above, the present invention also relates to a process for obtaining a final product in which the adhesive resin composition object of the present invention has been used.

This process is generally made up of the following steps:
Immerse a test material into the resin object of the present invention;
Let it dry;
To tape; and
Use a high temperature to activate the material and make it stick to the surface of the test materials.

In a particular embodiment, the conditions of step i) are: a resin concentration range of 10% to 40%, an immersion time of 0.5 to 5 minutes and a temperature of 20 to 50° C.

In a particular embodiment, the drying of step ii ) is carried out for a time of 0.5 to 10 minutes and with a controlled relative humidity of 50% to 60% at a temperature of 30 to 90° C.

In a particular embodiment, step iii ) the taping is carried out with a controlled relative humidity of 50% to 60% at a temperature of 20 to 50° C.

In another particular embodiment in step iv ), the temperature is in a range from 90 to 150° C. and also includes an activation time which is in a range from 10 to 30 minutes.

To obtain a better understanding of the invention described herein, the following examples are set forth below. It should be understood that these examples are for illustrative purposes only. Therefore, they should not limit the scope of this invention in any way.

### EXAMPLES

### Example 1. Adhesion Tests

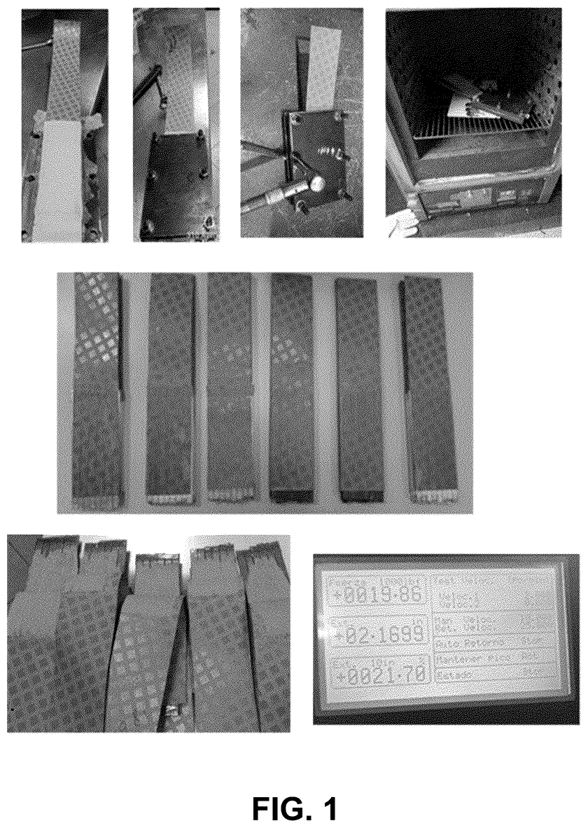

As shown in FIG. 1, adhesion tests were carried out between the polyimide tape and epoxy elements, since by their nature, these are incompatible for adhesion.

First, a commercial polyimide tape was purchased, which was impregnated by pouring the phenoxy resin/PU dispersion into a channel and immersing the tape and subsequently allowing it to dry, leaving the resin impregnated in the B-stage state.

Once the previous step was completed, the polyimide tape was rolled as shown in FIG. 3.

Subsequently, the rectangular aluminum wire measuring 79×335 thousandths of an inch with polyvinylformal coating was taped with the polyimide tape, obtaining a reel of the material.

From the aforementioned reel, cuts were made forming 48 slats of 18 cm each.

This polyimide tape is used in transformers, which use epoxy diamond paper (DDP), where the epoxy diamonds are in B-stage and are activated at temperatures above 120° C.

Six test pieces were then formed by joining eight 18 cm slabs together using a tape. Twelve 7×50 cm DDP blanks were then made. Two steel plates and two sheets of non-stick PTFE were used to form each test piece. The procedure for forming a test piece was as follows: screws with their respective washers were placed on the plates. The sheets of non-stick PTFE were placed and two DDP blanks were placed in the middle and a group of slabs were placed in the middle of the DDP blanks. The plates were closed and the nuts were tightened until reaching 50 N on each of the nuts. Finally, the plate was placed in a Type 1 forced convection oven at 120°C. for 1 hour as shown in FIG. 1. Once the time was up, the plates were removed from the oven, it was allowed to cool and the test piece was removed.

A peeling test was also performed, which is a standard method used to measure the resistance of an adhesive to separation between two surfaces. In this test, samples bonded with the adhesive in question are prepared and placed in a test rig that applies a controlled force in a direction perpendicular to the bonding interface. This force is then gradually applied to separate the bonded surfaces. The test can be performed at different angles, such as 180 degrees or 90 degrees, depending on the type of peel to be evaluated. The results are measured in terms of force per unit length and are used to evaluate the adhesion quality, compare different adhesives, and ensure that the products meet the required standards. In this particular case, the parameters set by ASTM D-1876 were followed.

In this sense, for the test, samples were manufactured with unmodified tape and modified tape in order to measure the difference in adhesion.

The results show that the material that previously had no adhesion in the Peel test, improved its adhesion considerably after the modification. The adhesion strength value using the peel test increased to 19.6 lbf for the case of the modification with polyurethane (PU) dispersion.

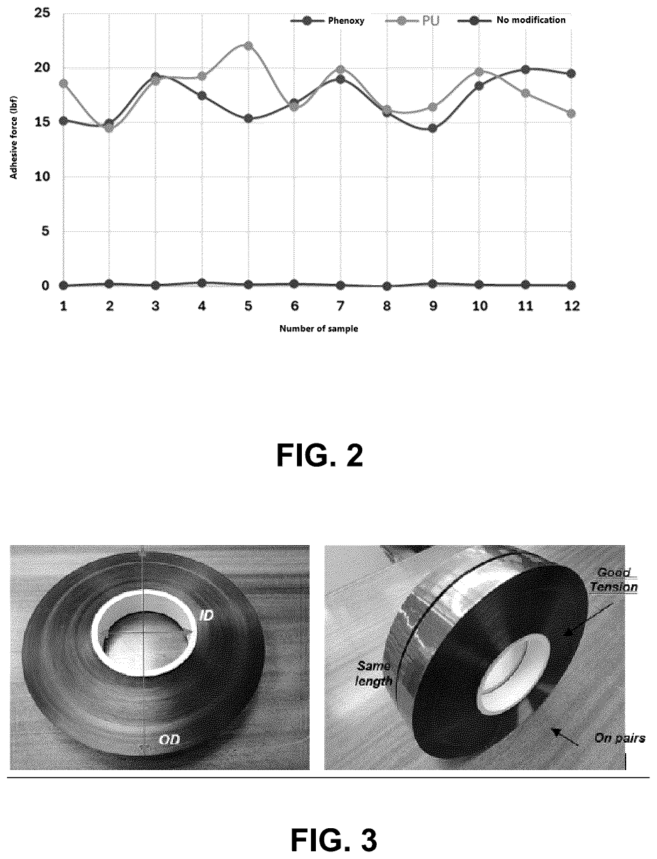

By making the comparative graph with the adhesion forces as shown in FIG. 2, the difference that exists between those test tubes in which there was no modification can be observed.

According to the above results, it can be concluded that the compositions of the resins object of the present invention manage to solve the problem of lack of adhesion of the tested material, since from being practically “zero” in the initial “Peel Test”, it increases to a minimum value corresponding to 14 lbf.

Many modifications and other embodiments of the invention will come to mind to one skilled in the art to which the invention pertains, having the benefit of the teachings presented in the foregoing descriptions and associated drawings. Therefore, it is to be understood that the invention is not to be limited to the specific and exemplary embodiments described, but that modifications and other embodiments are intended to be included within the scope of the appended claims. Although specific terms are employed herein, they are used only in a generic and descriptive sense and not for limiting purposes. It is also to be understood that the raw materials from which the various components comprising the invention described herein may be manufactured, and other elements may vary without departing from the scope and spirit of the invention and, therefore, the embodiments referred to are not to be construed as limiting.

1. An adhesive resin composition applied in coatings, industrial adhesives and on surfaces of different materials which have low thermodynamic compatibility due to their chemical and surface nature, characterized in that it comprises at least one dispersion of phenoxy resins in a range from 10% to 40% with respect to the total composition and/or at least one polyurethane dispersion having a viscosity value not greater than 100 cP,
wherein the dispersion of phenoxy resins comprises a homogeneous mixture in which the phenoxy resin particles are finely distributed in a solvent, and said dispersion is selected from the group comprising dispersions of phenoxy resins in organic solvents, dispersions of phenoxy resins in water, dispersions of high solids phenoxy resins, combinations thereof or the like; and
wherein the polyurethane dispersion comprises a homogeneous mixture in which the polyurethane is finely distributed in a solvent, and said dispersion is selected from the group comprising polyurethane dispersions in organic solvents, aqueous polyurethane dispersions, high solids polyurethane dispersions, combinations thereof or the like; and
wherein the resin allows for surface modification or adequate surface energy to facilitate adhesion between materials.

2. The adhesive resin composition according to claim 1, characterized in that the at least one phenoxy resin is a phenoxy resin in organic solvents.

3. The adhesive resin composition according to claim 2, characterized in that the organic solvents comprise highly volatile solvents such as methyl ethyl ketone (MEK), acetone, ethanol, toluene, and hexane, or combinations thereof and the like.

4. The adhesive resin composition according to claim 1, characterized in that the at least one polyurethane dispersion is synthesized by the solution polymerization method, wherein at least one polyol and at least one isocyanate are reacted in a 1:1 molar ratio in xylene.

5. The adhesive resin composition according to claim 4, characterized in that the at least one polyol is selected from the group comprising polyester diol polyols, polyester triol polyols, modified polyester polyols, poly(caprolactone ) diol, combinations thereof and the like.

6. The adhesive resin composition according to claim 4, characterized in that the at least one isocyanate is selected from the group comprising 4,4′-Methylenediphenyl diisocyanate (MDI), toluene diisocyanate (TDI), hexamethylene diisocyanate (HDI), isophorone isocyanate (IPDI), combinations thereof and the like.

7. The adhesive resin composition according to claim 1, characterized in that said composition has a viscosity not greater than 100 cP and when the solvent evaporates, the resin is semi-activated, so a temperature greater than 120° C. must be applied to activate it.

8. The adhesive resin composition according to claim 1, characterized in that the materials where the resin is applied are selected from the group comprising a polyimide film, a PET film, a polyamide film (Nylon 6), epoxy adhesives, combinations thereof and the like.

9. The adhesive resin composition according to claim 1, characterized in that the resin is applied in coatings and industrial adhesives to form a final product which is selected from the group comprising adhesives for automobiles, transformers, aerospace components, electronic devices, construction materials, packaging, textiles, combinations thereof or the like.

10. A manufacturing method for obtaining a final product from the resin according to claim 1, characterized in that it comprises the following steps:
a) Immerse a test material into the resin;
b) Let it dry;
c) To tape; and
d) Use a high temperature to activate the material and make it stick to the surface of the product.

11. The method according to claim 10, characterized in that in step a) the resin has a concentration range of 10% to 40%, a immersion time from 0.5 to 5 minutes and a temperature of 20 to 50° C.

12. The method according to claim 10, characterized in that step b) is carried out for a time of 0.5 to 10 minutes and with a controlled relative humidity of 50% to 60% at a temperature of 30 to 90° C.

13. The method according to claim 10, characterized in that step c) is carried out with a controlled relative humidity of 50% to 60% at a temperature of 20 to 50° C.

14. The method according to claim 10, characterized in that in step d) the temperature is in a range from 90 to 150° C. and also comprises an activation time which is in a range from 10 to 30 minutes.
